(19) United States
(12) Patent Application Publication
(10) Pub. No.: US 2005/0216680 A1
(43) Pub. Date: Sep. 29, 2005

(54) Device to allow multiple data processing channels to share a single disk drive

(76) Inventor: Itzhak Levy, Hollywood, FL (US)

Correspondence Address: LERNER AND GREENBERG, PA, P O BOX 2480, HOLLYWOOD, FL, 33022-2480, US

(21) Appl. No.: 10/809,233

(22) Filed: Mar. 25, 2004

(51) Int. Cl. G06F 12/16

(52) U.S. Cl. 711/162; 711/114

(57) ABSTRACT

The present invention relates to an intermediate hard disk drive adapter for a plurality of data processing channels and, in particular, to an inexpensive high performance, high reliability intermediate hard disk drive adapter for a number of data processing channels to share a single hard disk drive, each seeing the hard drive as its own.

### BACKGROUND OF THE INVENTION

1. Field of the Invention

The invention lies in the computer storage technology field. More specifically, the invention relates to an intermediate hard disk drive adapter for computer data processing systems.

The term “computer data processing system” as used herein should be understood in a very wide sense of the term. The most common use of the invention will likely be in applications such as telephony or video processing where a number of data processing channels are situated on circuit boards within a single chassis, each channel containing its own computer system. The device according to the invention will also work with a multitude of other devices such as desktop computers, point-of-sale terminals, computer numerical controllers, medical testing and monitoring equipment, and many other similar systems and devices. The invention should be understood to broadly apply to all such systems and devices.

2. Description of the Related Art

Computer data processing systems normally use a hard disk drive to store programs and data. Additionally, a hard disk drive is usually used to store the programs and information necessary to power up (bootstrap) the computer system.

The size of presently available hard disk drives has increased enormously. In many cases the size of the smallest available hard disk drive is several times larger than the requirements of the computer system, particularly computer systems dedicated to a single data processing application.

Hard disk drives require a significant amount of power to operate. Additionally, they require space usually within the enclosure of the computer system. In the case of small, specialized computer systems, power and space requirements place a significant burden on the system design. Additionally, the cost of a hard disk drive represents a significant part of the cost of a small computer system.

The increased use of computer systems has resulted in many situations where a number of data processing systems are located in close proximity to each other. Frequently these computer systems consist of a plurality of dedicated data processing circuit boards contained within a single chassis, each consisting of a central processor and specialized connections for handling data.

### SUMMARY OF THE INVENTION

It is accordingly an object of the invention to provide a means of sharing a single hard disk drive between a number of data processing channels with the resultant savings of cost, power consumption, and space.

The present invention involves the use of an intermediate hard disk controller that allows a number of data processing channels to each access a single hard disk drive. The hard disk drive and the intermediate hard disk controller are configured such that each data processing channel “sees” a portion of the hard disk drive that has been allocated to it as if it were a single hard disk drive.

The intermediate hard disk controller and hard disk drive would typically be located inside a chassis containing one or more data processing channels or as a stand-alone unit. The various data processing channels would be connected to the intermediate hard disk controller by cables or connectors. This cable carries signals using one of a number of present or future communication protocols depending on the data transmission speed required and the distance between the data processing channels and the intermediate hard disk controller. Communication protocols might include Parallel ATA, IEEE 1394 (“Firewire”), Universal Serial Bus (USB), Serial ATA (SATA), and others.

Advantages of the present invention include:
lower system cost by using a single hard disk drive instead of many;
lower power consumption;
simpler and smaller data processing channel design; and
no reduction in system performance.
Smaller footprint

Additionally, the present invention can be combined with another hard disk drive to offer RAID for data security. In this configuration, a second, identical or larger, hard disk drive would be provided. Whenever data is written, it is written to both drives. If a hard drive should fail, all programs and data are safely protected on the second hard disk drive and can be restored to a replacement hard disk drive. In normal operation, data can be simultaneously read from both drives with a resultant increase of speed.

The invention is entirely a hardware implementation. The data processing channel and its operating system have no cognizance of the invention. Thus the invention is completely transparent to the type of computer or its operating system. Indeed, data processors with dissimilar operating systems can use the invention.

With the foregoing and other objects in view there is provided, in accordance with the invention, a number of data processing channels, each comprising a processor generating data output, a hard disk drive adapter designed to function as an intermediate adapter connected to receive the data output from the processors and configured to send the data output to a single channel, and a data storage device connected to the intermediate adapter and receiving the data output of the channel.

In accordance with another feature of the invention, the intermediate adapter is configured to implement substantially automatic data multiplexing between a number of data processing channels and a single hard disk drive.

The invention has several advantages. By way of example, inter alia, the invention
allows a number of data processing channels to share a single hard disk drive;
reduces overall power consumption;
reduces the space requirement for many hard disk drives,
does not use other central processor resources such as expansion card slots, interrupts, input/output space, and address space,
provides an intermediate adapter designed to function without requiring device drivers or any support by the operating systems themselves;
can be easily combined with a second hard disk drive for instantaneous data backup (RAID), providing much greater data security;
in systems with a second hard disk drive, the second drive can be removable for data portability; and
reduces overall system cost. Since larger hard drives sell for a lower cost per amount of data stored, there is a large cost advantage to sharing a single hard disk between a number of data processing channels.

Other features which are considered as characteristic for the invention are set forth in the appended claims.

Although the invention is illustrated and described herein as embodied in a system in which a plurality of data processing channels share one disk drive, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawing.

### BRIEF DESCRIPTION OF THE DRAWINGS

FIG. 1 is a schematic perspective view illustrating a system according to the prior art, containing a number of data channels each connected to a dedicated hard disk drive;

FIG. 2 is a similar view of a system according to the invention, incorporating the novel interface and using a single hard disk drive;

FIG. 3 is a block diagram showing a system with the novel interface according to the invention;

FIG. 4 is a similar block diagram showing a system incorporating the novel interface and providing for drive mirroring;

FIG. 5 is a table indicating the contents of a typical 40 GB hard disk drive;

FIG. 6 is cross-reference, in tabular form, containing the physical partitions and the logical partitions of a hard disk drive according to the invention;

FIG. 7 is a table with calculated block numbers using the data of FIG. 6; and

FIG. 8 is a block diagram of a system for calculating desired block numbers.

### DESCRIPTION OF THE PREFERRED EMBODIMENTS

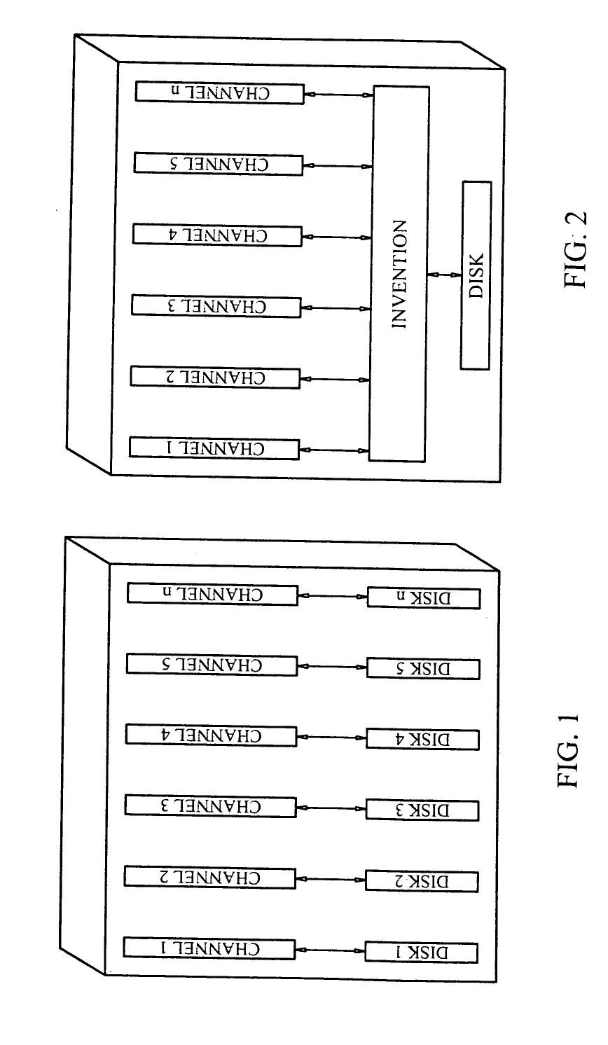

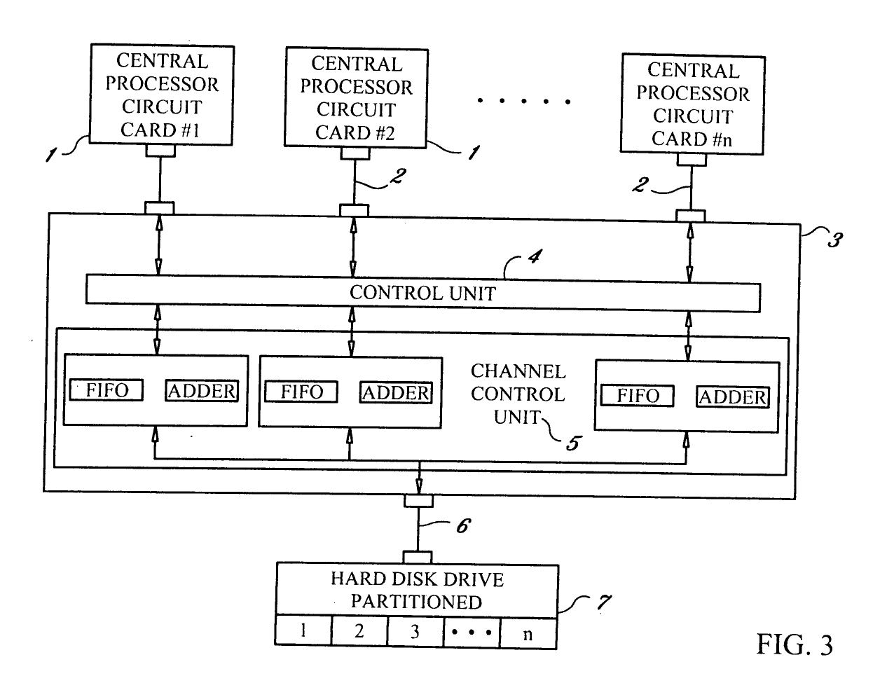

Referring now to the figures of the drawing in detail and first, particularly, to FIGS. 1 and 2 thereof, the prior art is known to provide one hard disk drive to each channel, whether the channel be incorporated in a single box or a distributed system. FIG. 2 provides for a disk drive sharing interface and, as the illustration shows, several data processing channels are connected to and use a single hard disk drive. With reference to FIG. 3, there is shown a block diagram illustrating, by way of example, a number of central processors 1 communicating with an intermediate adapter 3. The processors are shown as circuit cards that could be located within a single chassis; however, this is not a requirement.

The intermediate adapter 3 according to the invention has a control unit 4 which communicates with the central processors via cables or connectors 2. The control unit 4 accepts commands from the central processors 1 and generates several signals into channel control unit 5. In the case where data is requested to be transferred to or from the hard disk drive, the control unit selects the partition of the hard disk drive to be written or read and directs the data to or from the requesting data processing channel. The channel control unit 5 contains a First-In-First-Out (FIFO) memory device in each channel for buffering the data, in both directions between each central processor 1 and the hard disk drive 7. It also contains an adder to calculate the physical address on the hard disk drive 7 from the address desired by the central processor 1. The channel communicates with the hard disk drive via a cable or connector 6.

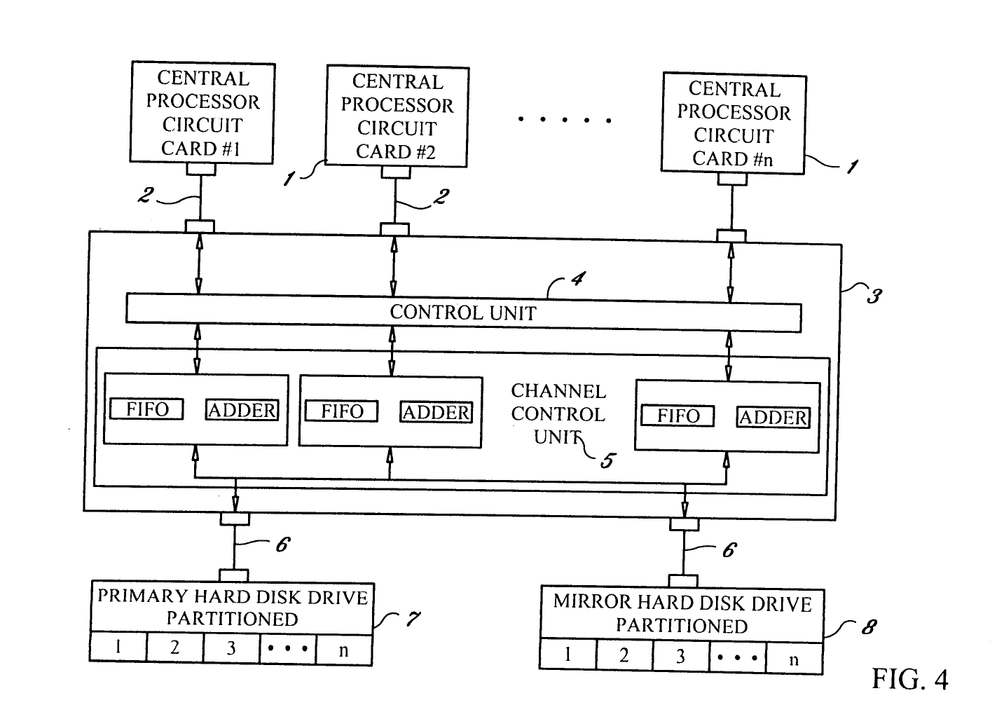

FIG. 4 is similar to FIG. 3 except that a second redundant hard disk drive 8 has been added to allow instantaneous data backup. Specific information with regard to data backup and mirroring is not necessary here, as such information belongs to the general state of the art. Additional information and new information concerning backup and drive technology is found in my co-pending patent application entitled Hard Disk Automatic Hardware-Based Scheduled Archiving (Atty. Docket F-8464), which is herewith incorporated by reference.

The following paragraphs describe the unique method by which the invention stores and retrieves information from different partitions of the hard disk drive.

Data is stored on hard disks in quantities of 512 bytes of information. These are known as “blocks”. Each block is located by a unique number, or address. This address is known as its “Logical Block Address” or “LBA” for short. For example a 40 Gigabyte (GB) hard drive would have 83,886,080 blocks, with addresses numbered from 0 to 83,886,079. In most cases, without the invention, the software operating system stores information in specific blocks to allow the computer to power up (bootstrap) properly and to be able to efficiently find where various programs and data are stored on the hard disk.

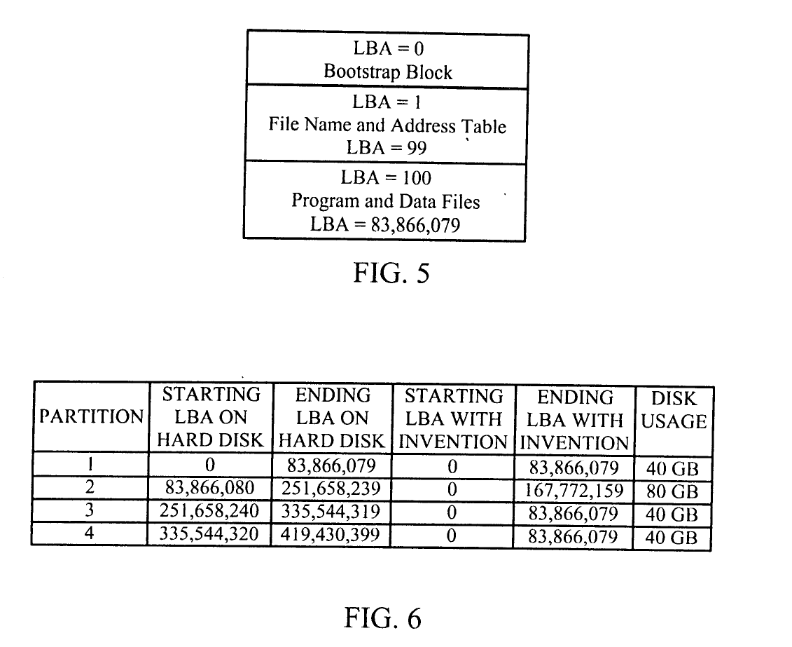

While the invention is oblivious to the nature of the data stored on the hard disk drive, a typical operating system might consist of a bootstrap block at the first block, then an index table of program and data files on the hard disk and where they are located. This would be followed by the program and data files, themselves. FIG. 5 is an illustration of the typical contents of a 40 GB hard disk.

This invention is unique in that it uses a hard disk that is several times larger than the amount of storage space that is required by the data processing channels. Referring to FIG. 6, as an example, this invention modifies the logical block addresses of the hard disk so that the each data processing system sees one of four drives. Each drive, as seen by the data processing channel, appears to have the same block addresses as the system disk that would be required for each data processing system if it were not for the invention. Thus each data processing system can power up and access all program and data files as if it had its own dedicated system disk. Each dedicated like system disk is a fully bootable partition independent of the other partitions since each partition has a full image copy of the O/S. Note that the individual partitions in this example are of dissimilar size.

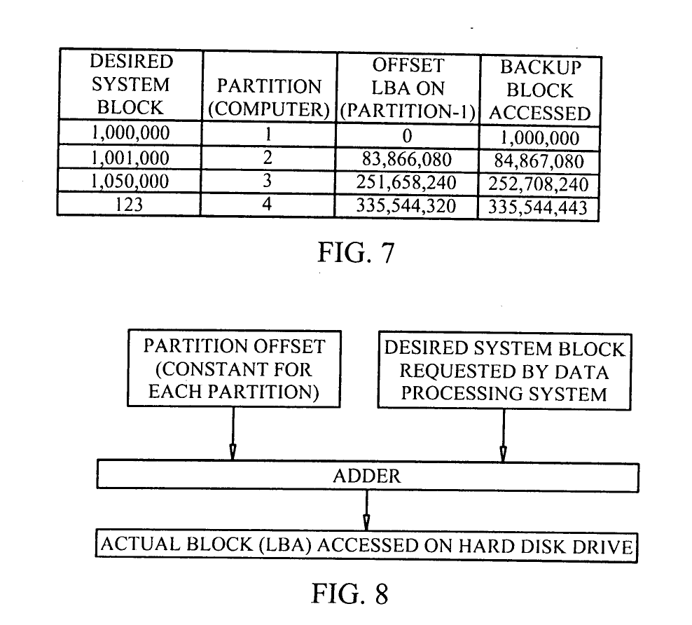

The address of the desired block to be accessed on the hard disk is calculated by adding an offset to the address of the block desired by the data processing channel. This offset for each partition is calculated by adding the total number of logical blocks of each of the preceding partitions. Examples of calculated block numbers using the data in FIG. 6 are shown in FIG. 7. The method of calculating desired block numbers is illustrated in FIG. 8.

1. A computer system, comprising:
a plurality of data processing channels requiring data input and generating data output;
a hard disk drive adapter connected to each of said plurality of data processing channels; and
a single hard disk drive connected to said hard disk drive adapter;
said hard disk drive adapter forming an intermediate adapter for transferring data between said plurality of data processing channels and said single hard disk drive.

2. The computer system according to claim 1, which further comprises a data storage device connected to said hard disk drive adapter for transferring data via said hard disk drive adapter in accordance with a given communications protocol.

3. The computer system according to claim 2, wherein the given communications protocol used by said data storage device is any present or future data storage device communications protocol.

4. The computer system according to claim 1, wherein said intermediate adapter is configured to transfer the data from each of said plurality of data processing channels to said hard disk drive, substantially without using any processing channel resources.

5. The computer system according to claim 1, wherein said plurality of data processing channels are central processors each with a hard disk drive connector communicating with said intermediate adapter via cables or connectors.

6. In a computer system with a plurality of data processing channels having processors generating data output, a data storage and transfer system, comprising:
a data storage device having a data storage capacity at least as large as a maximum storage capacity required by the channels of the plurality of data processing channels combined, and having parts each assigned to a respective one of the plurality of data processing channels;
an intermediate adapter connected between the plurality of data processing channels and said data storage device for transferring data between the data processing channels and said data storage device;
said intermediate adapter including a device for distributing the data being transferred between said data storage device and the plurality of data processing channels; and
wherein said intermediate adapter connects each of the plurality of data processing channels to a respective said part of said data storage device.

7. The computer system according to claim 6, wherein said intermediate adapter comprises means for calculating an actual storage location on the data storage device assigned to a respective one of the data processing channels.

8. The computer system according to claim 6, wherein the parts of the data storage device assigned to the plurality of data processing channels are physical partitions.

9. The computer system according to claim 6, wherein said data storage device is a partitioned hard disk drive.

10. The computer system according to claim 6, which comprises a plurality of cables or connectors connecting channels of said intermediate adapter to said data storage device.

11. The computer system according to claim 10, wherein said data storage device a fixed or removable data storage device.

12. The computer system according to claim 6, wherein said intermediate adapter is configured to be entirely transparent to an operation of the data processing channel and said data storage device.
